(19) United States
(12) Patent Application Publication
(10) Pub. No.: US 2006/0262492 A1
(43) Pub. Date: Nov. 23, 2006

(54) Power supply of a computer with a power output device

(76) Inventor: Tsung Yen Tsai, Taipei Hsien (TW)

Correspondence Address: Tsung Yen Tsai, 235 Chung - Ho, Box 8-24, Taipei, TW

(21) Appl. No.: 11/130,053

(22) Filed: May 17, 2005

(51) Int. Cl. H02B 1/00

(52) U.S. Cl. 361/601

(57) ABSTRACT

A power supply of a computer has a power output device. The power output device comprises one power output port; at least one relay module; one end of the at least one relay module having one power input port connected to the one power output port; and another end of the relay module having a plurality of slots; and a plurality of first conductive wires; one end of each first conductive wire being connected to a connecting plug and another end of the first conductive wire being connected to an external plug; the connecting plug being connected to one of the slot and the external plug being connected to a computer peripheral device. Furthermore, each relay module may have a first module and a second module; one end of the modules being installed with a power input port and another end thereof being installed with a plurality of slots.

### FIELD OF THE INVENTION

The present invention relates to power supplies, and in particular to a power output device of a power supply of a computer. In that the wires are arranged orderly so that more space is provided for arranging other devices and elements and providing effective heat dissipation.

### BACKGROUND OF THE INVENTION

Generally, a personal computer comprises a motherboard, a central processing unit (CPU) interface cards, and data access units (such as a hard disk drive, a compact disk drive, a card reader) and other peripherals. The power of these devices are based on the power supply at a rear side of a computer casing. Referring to FIG. 1, a prior art power supply 1 has a bundle of outer wires 1 for being connecting to a power source. The output wires include a main cable 12, a first sub cable 13 and a plurality of second sub-cables 14. The main cable 12 and first sub cable 13 are used by the motherboard and the central processing unit (CPU) interface card. The second sub cables 14 are connected to a plurality of stud plugs 15 for supplying power to the data accessing units and other peripherals. In the prior art, the power supply 1 uses output wires 11 for supplying power. This way has been adapted for many years. The output wires are arranged disorderly in the computer casing. However currently, the sizes of computer casings are made smaller and smaller. The arrangement of the wires causes air not to be flow effectively so that heat dissipation of electronic elements can be not performed effectively.

To improve above mentioned defects, an output connector 22 is installed at the casing 21 of the power supply 2 (referring to FIG. 2). Then a connecting wire 23 serves to output power of the power supply 2 to peripherals of the computer casing (not shown). However the above mentioned power supply 2 is connected to the output connector 22 through the connecting wire 23. As comparing with the conventional connecting wires 11 of the power supply 1 (referring to FIG. 1), the connecting wire 23 is selected, but it is still arranged within a housing disorderly. Furthermore, in maintenance, the connecting wire 23 must be detached, the operation is inconvenient. When the power supply 2 is used with computers of different types (such as personal computers, commercial computers and servos are computers of different types), other than requirement of output power is different, for power supplies of different output powers, the types and numbers of connecting wires are different. Thereby the manufacturer must use output connectors of different types or numbers of slots to match the power supplies. Thus the process is tedious and a great number of stocks are required.

### SUMMARY OF THE INVENTION

Accordingly, the present invention provides a power output device of a power supply of a computer. In that the wires are arranged orderly so that more space is provided for arranging other devices and elements and providing effective heat dissipation.

To achieve above object, the present invention provides a power supply of a computer which comprises one power output port; at least one relay module; one end of the at least one relay module having one power input port connected to the one power output port; and another end of the relay module having a plurality of slots; and a plurality of first conductive wires; one end of each first conductive wire being connected to a connecting plug and another end of the first conductive wire being connected to an external plug; the connecting plug being connected to one of the slot and the external plug being connected to a computer peripheral device.

Furthermore, the present invention provides a power supply of a computer having a power output device; the power output device. The device comprises two power output ports; at least one relay module; each relay module has a first module and a second module; one end of first and second module being installed with a respective power input port and another end thereof being installed with a plurality of slots; and a plurality of first conductive wires; one end of each first conductive wire being connected to a connecting plug and another end of the first conductive wire being connected to an external plug; the connecting plug being connected to one of the slot and the external plug being connected to a computer peripheral device.

The various objects and advantages of the present invention will be more readily understood from the following detailed description when read in conjunction with the appended drawing.

### BRIEF DESCRIPTION OF THE DRAWINGS

FIG. 1 is a perspective view of a prior art power supply.

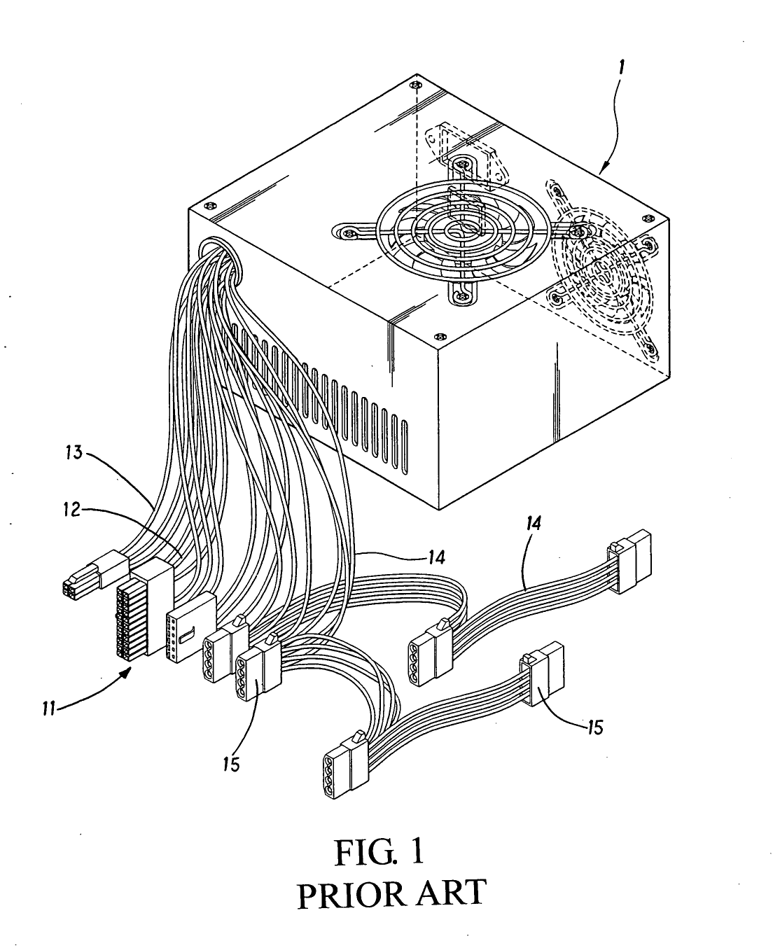

FIG. 2 is an assembled schematic view of another prior art power supply and connecting wires.

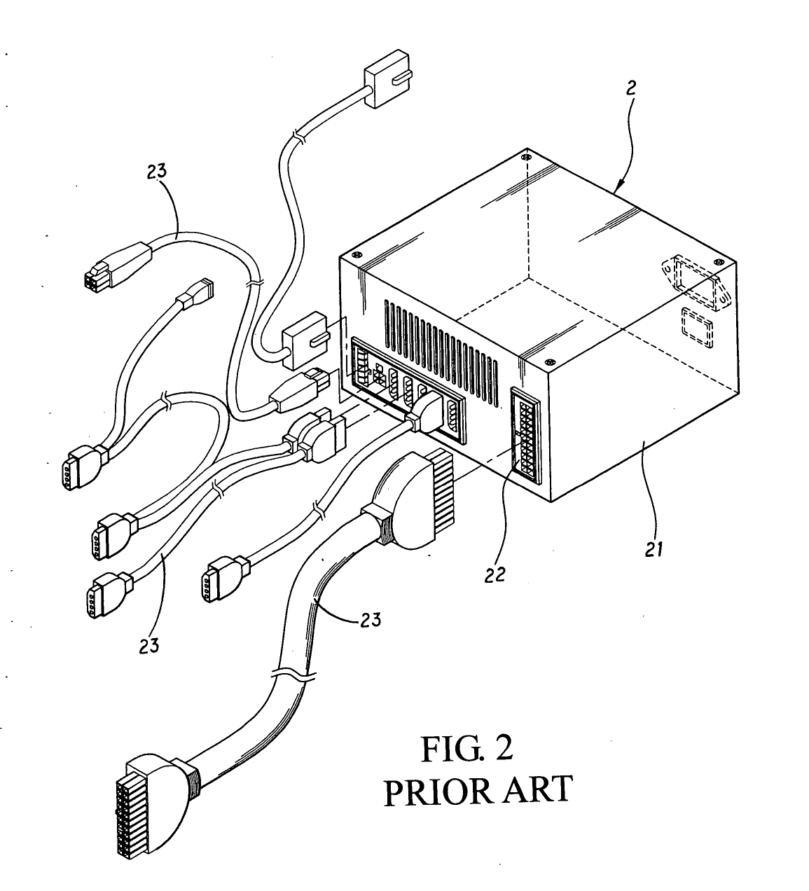

FIG. 3 is an exploded perspective view of the first embodiment of the present invention.

FIG. 3A shows the relay module of the present invention which is viewed from another aspect according to first embodiment of the present invention.

FIG. 4 is an exploded perspective view of first embodiment of the present invention.

FIG. 4A is a schematic view showing an use of the present invention, where the present invention is installed within a computer casing according to the first embodiment of the present invention.

FIG. 4B is a schematic view showing the present invention being installed within a computer casing, which is connected to a relay module through conductive wires.

FIG. 5 is an exploded perspective view of the second embodiment of the present invention.

FIG. 5A shows one example of the relay module according to the present invention.

FIG. 6 is an assembled perspective view of the second embodiment according to the present invention.

FIG. 6A shows the use f the present invention which it is installed within a computer casing according to second embodiment of the present invention.

FIG. 6B shows a use of the present invention, wherein the present invention is installed within a computer casing, which is further connected to a relay module through conductive wires.

FIG. 7 is an exploded perspective view according to third embodiment of the present invention.

FIG. 7A shows the relay module according to third embodiment of the present invention, which is viewed from another aspect.

FIG. 8 is an assembled perspective view according to third embodiment of the present invention.

FIG. 8A shows a use of the present invention according to third embodiment of the present invention, wherein the present invention is installed within a computer casing.

FIG. 8B shows a use of the present invention, wherein the present invention is installed within a computer casing, which is connected to a relay module through conductive wires.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

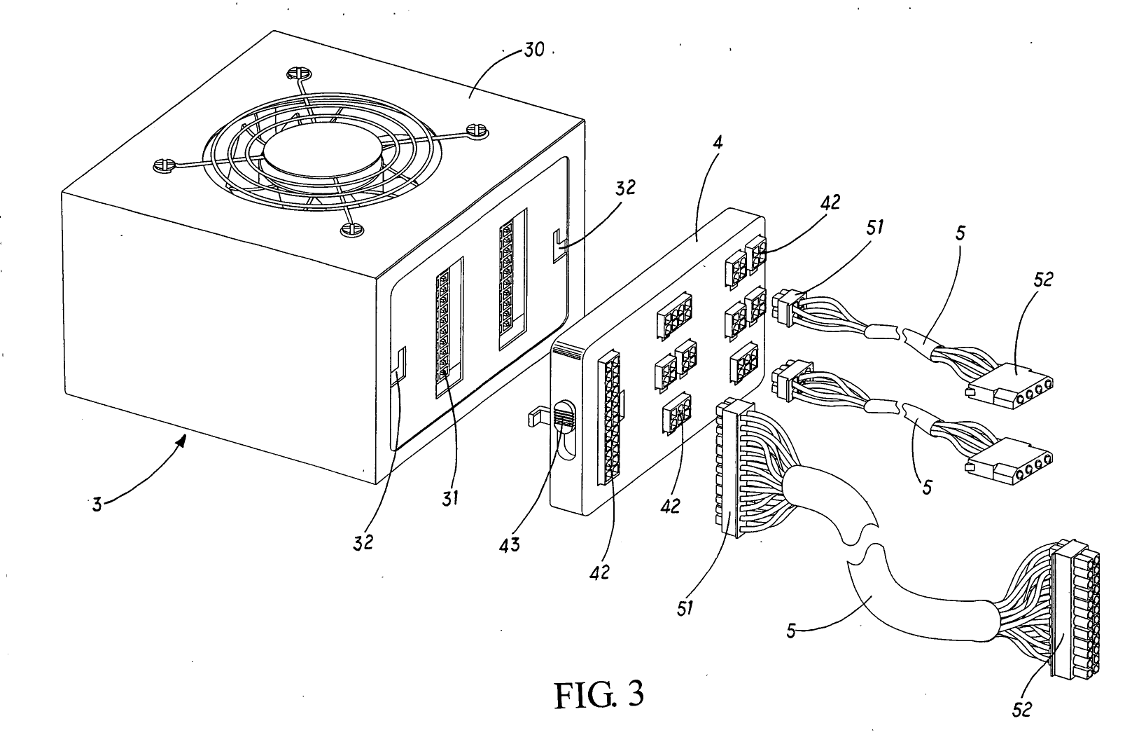

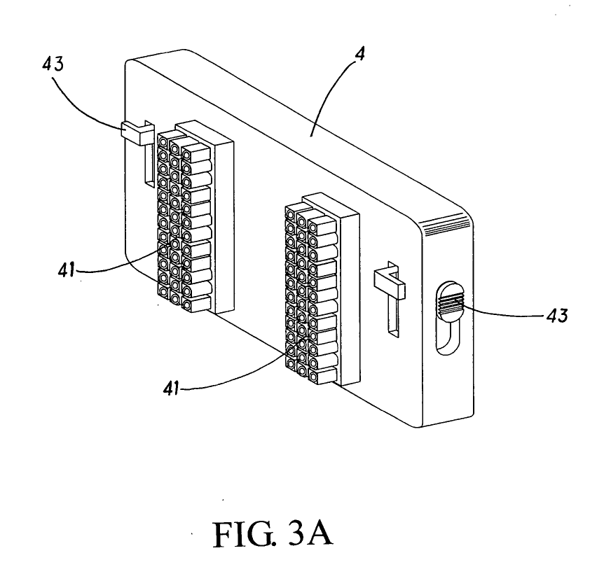

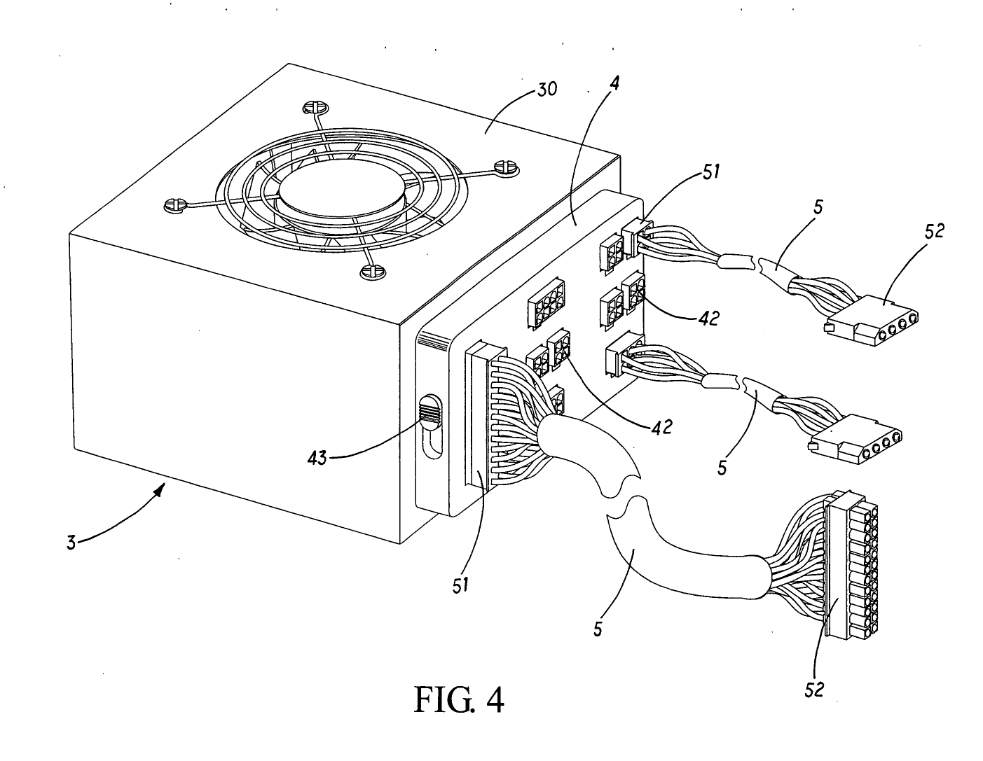

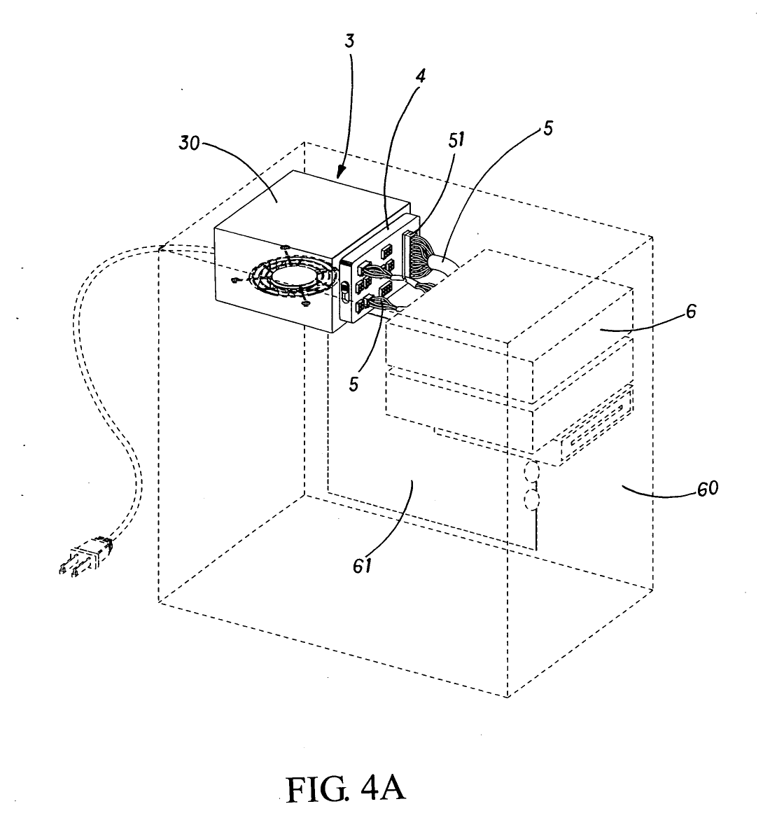

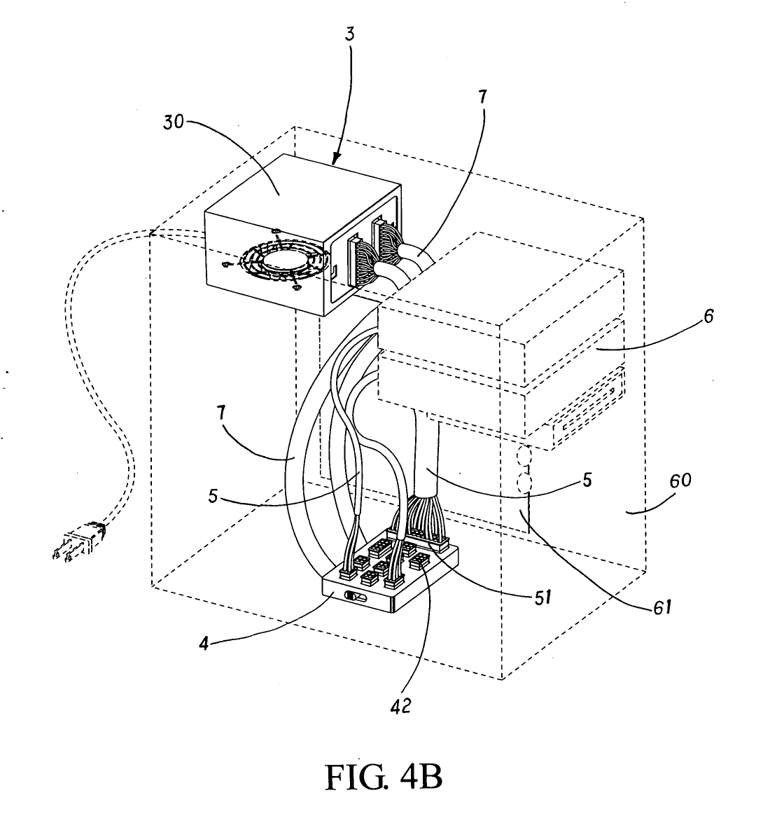

With reference to FIGS. 3 to 4, the power output device of a power supply is illustrated. The casing 30 of the power supply 3 is installed with a power output port 31. The power output port 31 is a female seat (or a male set). A relay module 4 has one end which is installed with a power input port 41 connected to the power output port 31. The power input port 41 is a male seat (or a female seat) corresponding to the power output port 31. Another end of the relay module 4 is installed with a plurality of slots 42 (referring to FIG. 3B). There are plurality of conductive wires 5. One end of each conductive wire 5 is connected to a connecting plug 51 and another end thereof is connected to an external plug 52. The external plug 52 is connected to a peripheral 6 of a computer. Thereby the power supply 3 is installed with a computer housing 60. The power input port 41 of the relay module 4 is connected to the power output port 31. A lateral side of the relay module 4 has a buckle 43 which is buckled to one embedding groove 31 of the casing 30. The relay module 4 is positioned at one side of the casing 30 of the power supply 3. The connecting plug 51 of the conductive wire 5 is connected to the slot 42 of the relay module 4, the external plug 52 and a mother board 61, and the peripheral device 6 so that the power from the power supply 3 is transferred to the mother board 61, and the peripheral device (referring to FIG. 4A) to provide power to these devices. Referring to FIG. 4B, it is illustrated that the present invention is installed to a computer casing and is connected to the relay module 4 through conductive wires 7. Two ends of each conductive wire 7 have respective joints. One end of the conductive wire 7 is connected to the female seat (or male seat) of the power output port 31 and another end of the conductive wire 7 is connected to the male seat (or female seat) of the power input port 41 of the relay module 4. By above mentioned way, by the conductive wires 7, the relay module 4 can be installed far away from the power supply 3 and near the motherboard 61 of the computer, and the peripheral device 6 so that the layout and connection of the computer casing 60 are simplified greatly. Furthermore, the air convection and heat dissipation are increased in the casing.

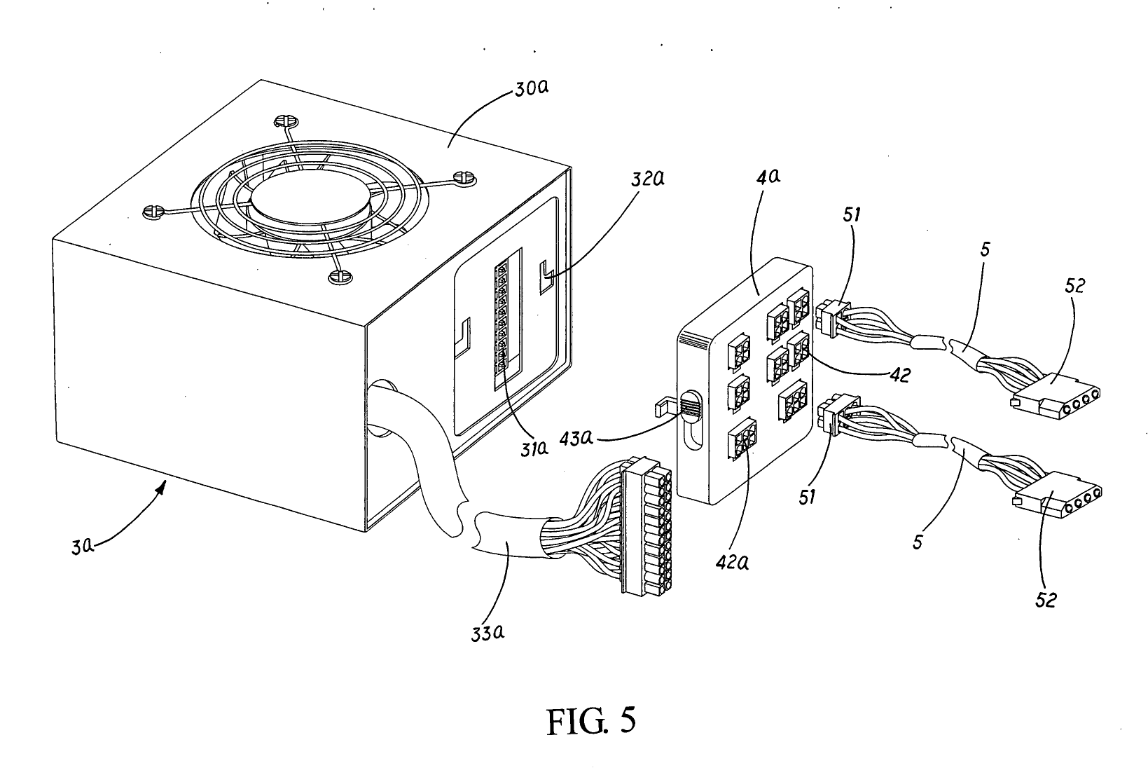

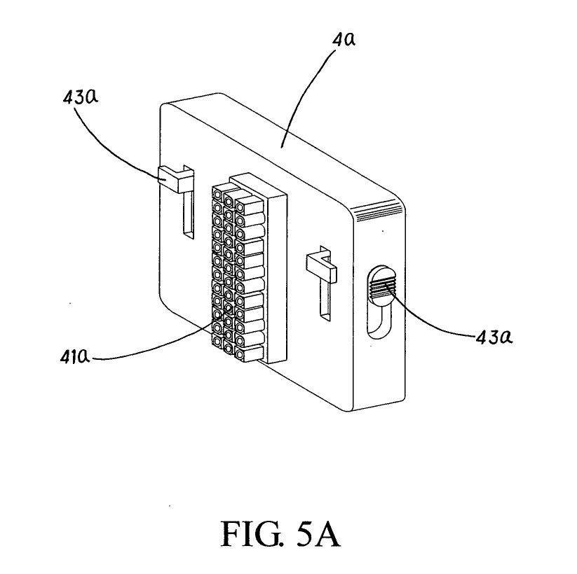

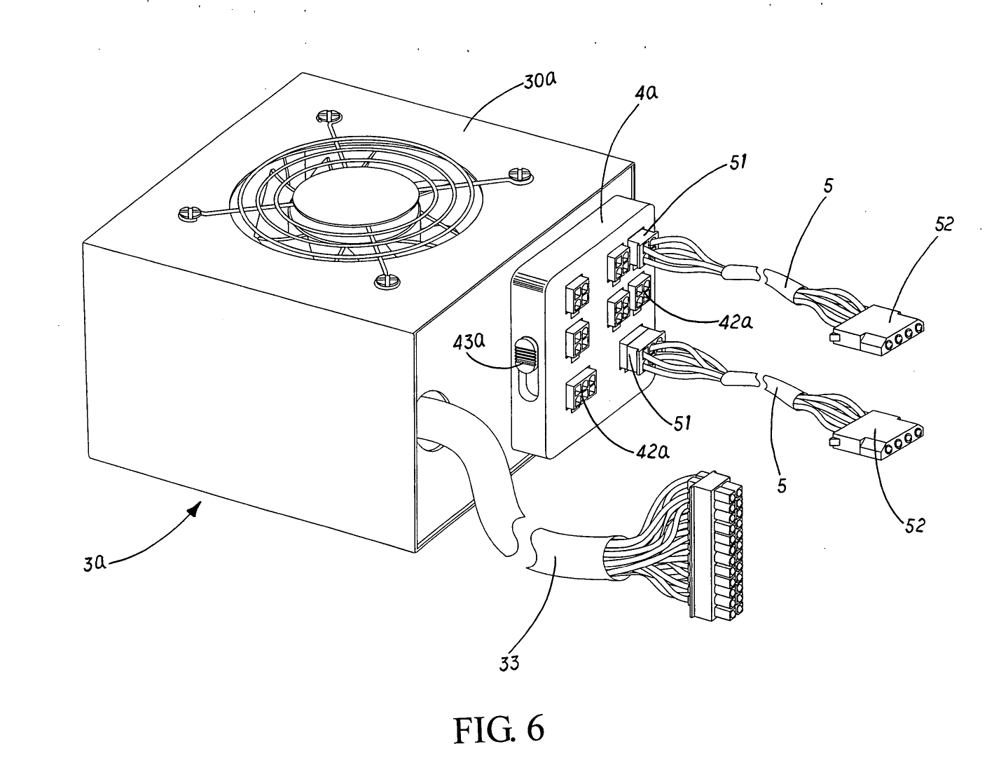

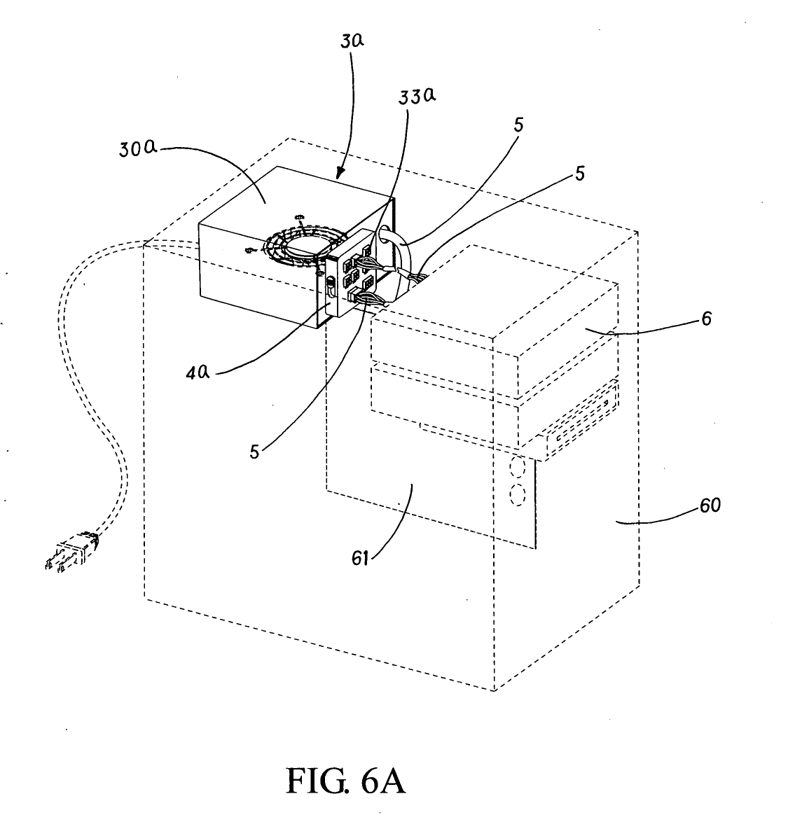

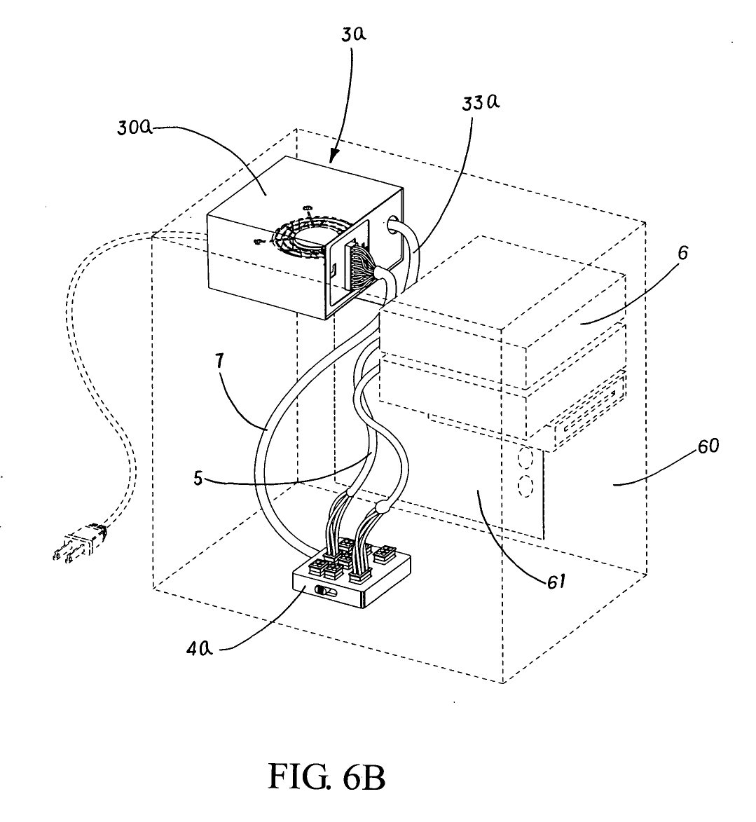

Referring to FIGS. 5 to 6, the second embodiment of the present invention is illustrated. The casing 30a of the power supply 3a is installed with a main cable 33a and a power output port 31a. The power output port 31a is a female seat (or a male seat). One end of the relay module 4a is installed with a power input port 41a which is connected to the power output port 31a. The power input port 41a is a male seat (or a female seat) corresponding to the power input port 41a. Another end thereof has a plurality of slots 42a (referring to FIG. 5A). One end of each conductive wire 5 is connected to a connecting plug 51 and one of the slot 42a and another end of each conductive wire 5 is connected to an external plug 52. The external plug 52 is connected to a peripheral device 61. The power input port 41a of the relay module 4a is connected to the power output port 31a of the casing 30a. A buckle 43a of the relay module 4a is buckled to the embedding groove 321 of the casing 30a so as to position the relay module 4a to one side of the casing 30a. Thereby the power outputted from the power supply 3a is transferred through a main cable 33a to a mother board 61 and is also transferred to the peripheral device 6 (referring to FIG. 6A) through the conductive wires 5. By this embodiment,

With reference to FIG. 6B, it is illustrated that the present invention is installed to a computer casing and is connected to a relay module through conductive wires. One end of the conductive wire is connected to the power output port 31a of the casing 30a and another end thereof is connected to the power input port 41a of the relay module 4a. By above mentioned way, by the conductive wires 7, the relay module 4a can be installed far away from the power supply 3a and near the motherboard 61 of the computer, and the peripheral device 6 so that the layout and connection of the computer casing 60 are simplified greatly. Furthermore, the air convection and heat dissipation are increased in the casing.

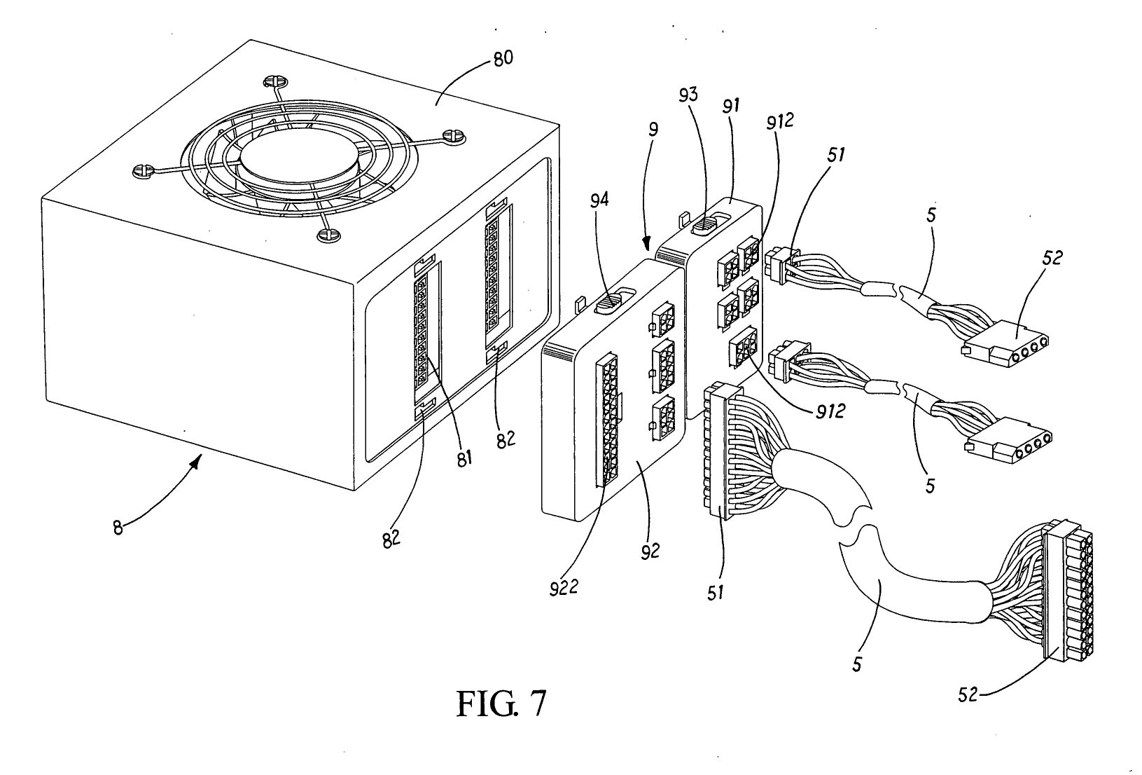

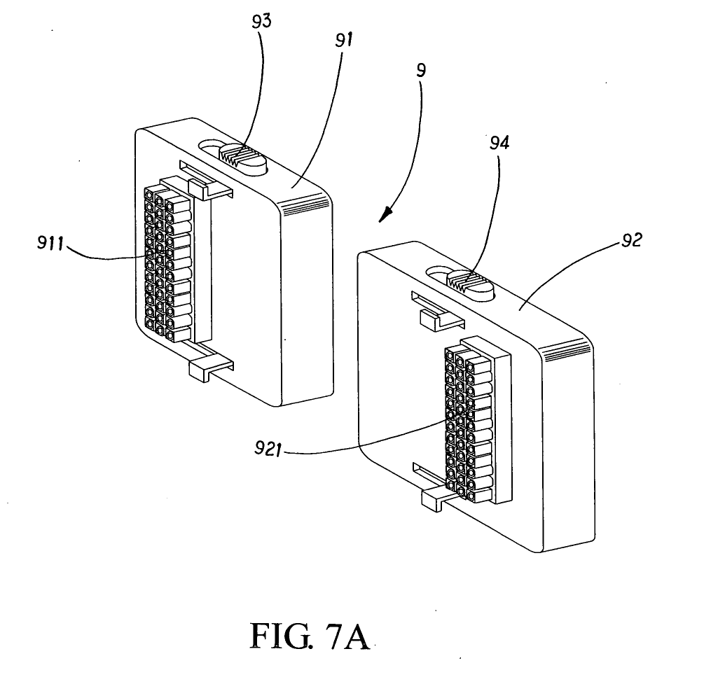

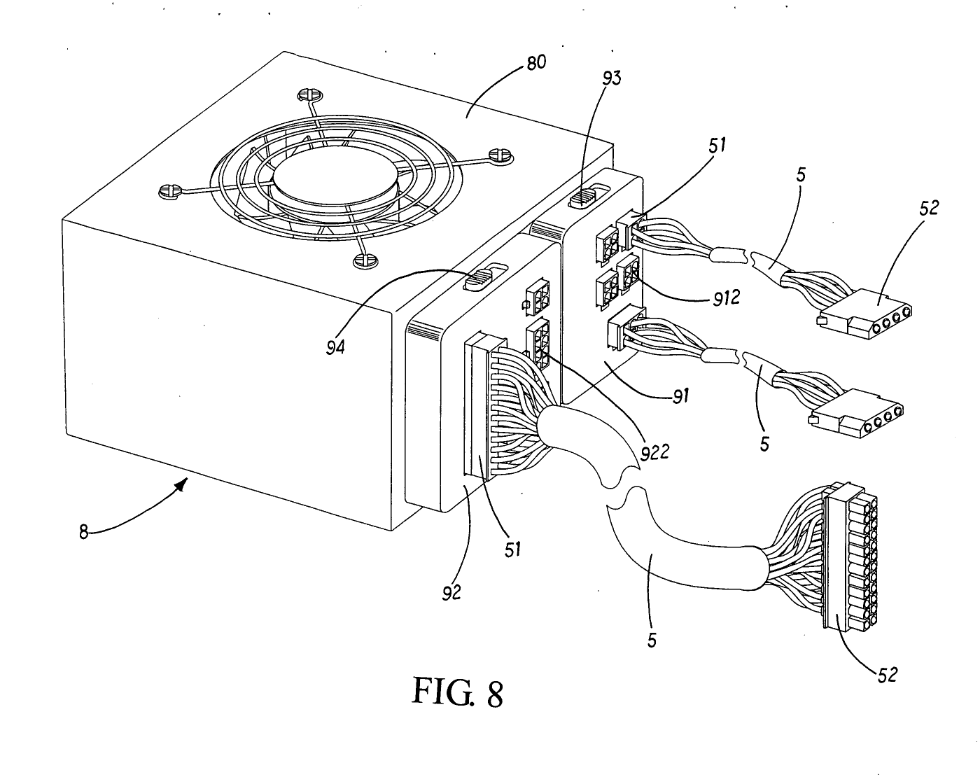

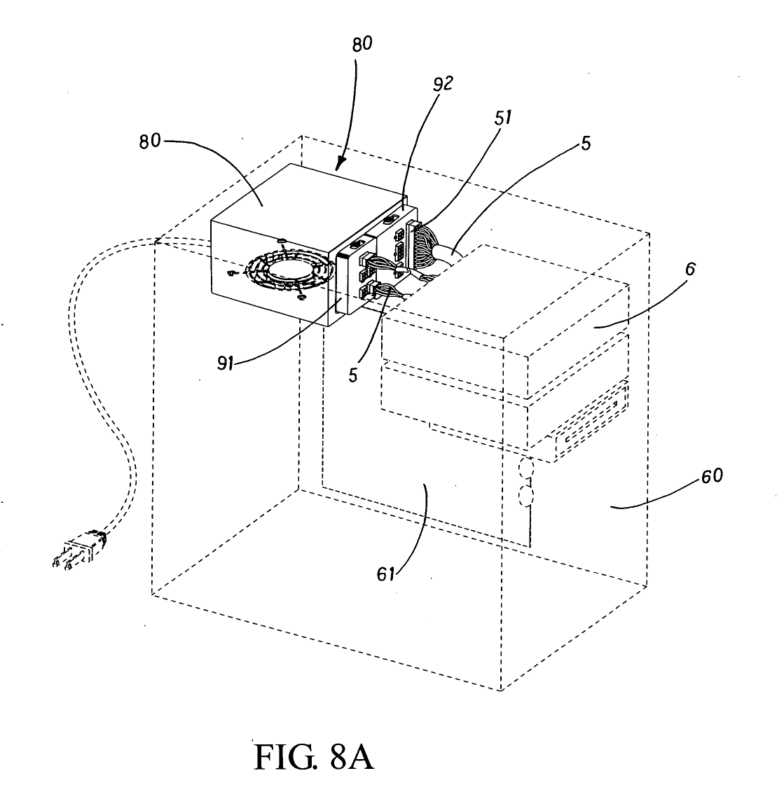

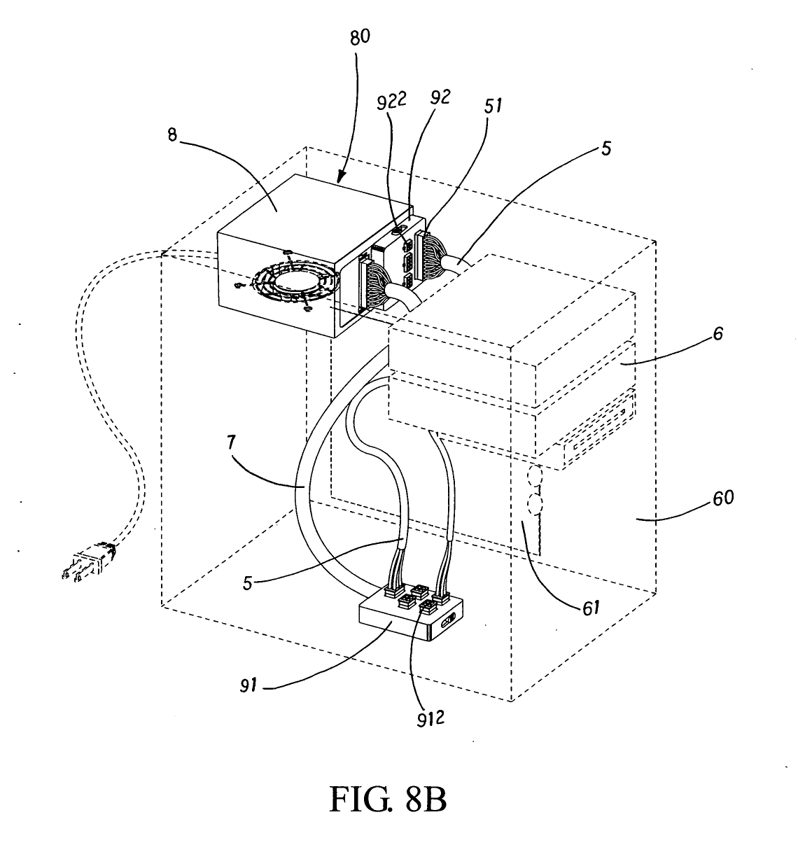

Referring to FIGS. 7 to 8, the third embodiment of the present invention, the casing 80 of the power supply 8 is installed with two power output ports 81. A relay module 9 has a first and a second module 91, 92. One end of each module has a power input port 911, 921 corresponding to the power output port 81 and another end thereof is formed with a plurality of slots 912, 922 (referring to FIG. 7A). A connecting plug 51 of each conductive wire 5 is connected to the slot 912, 922 and an external plug 52 of each conductive wire 5 is connected to a computer device 6. Thereby the first and second modules 91, 92 of the relay module 4 are buckled to the embedding grooves 82 of the casing 80 by the buckles 93, 94 so as to position the first and second modules 91, 92 to one side of the casing 80. The power outputted from the power supply 8 is transferred to the motherboard and the peripheral device 6 (referring to FIG. 8A). Referring to FIG. 8A, one operation of the present invention is illustrated. The first and second modules 91, 92 are installed with conductive wires 5 so as to provide power to the motherboard 81 and the peripheral device 6 (referring to FIG. 8A). Referring to FIG. 8B, the first and second modules 91, 92 are installed with power input ports 911, and 912. In use, the power input port 911 of the first module 91 and/or the power input port 921 of the second module 92 is connected to the conductive wire 7 so that the first module 91 and/or second module 92 is installed far away from the power supply 8 but near the motherboard 61 and the peripheral device 6. Thereby the relay module 9 is assembled or detachable to be suitable for different computer casing 60.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power supply of a computer having a power output device; the power output device comprising:
one power output port;
at least one relay module; one end of the at least one relay module having one power input port connected to the one power output port; and another end of the relay module having a plurality of slots; and
a plurality of first conductive wires; one end of each first conductive wire being connected to a connecting plug and another end of the first conductive wire being connected to an external plug; the connecting plug being connected to one of the slot and the external plug being connected to a computer peripheral device.

2. The power supply of a computer as claimed in claim 1, wherein a casing of the power supply is installed with a main cable and the power output port.

3. The power supply of a computer as claimed in claim 1, wherein the power output port has a seat which is selected from one of a male seat and a female seat and the power input port has a seat which is selected from one of a male seat and a female seat; the seat of the power input port is insertable into the seat of the power output port.

4. The power supply of a computer as claimed in claim 1, wherein the power output port is connected to the power input port through at least one second conductive wire.

5. The power supply of a computer as claimed in claim 3, wherein the seat of the power output port is connected to the seat of the power input port through at least one second conductive wire.

6. The power supply of a computer as claimed in claim 1, wherein a lateral side of the relay module is installed with a buckle and the casing is formed with an embedding groove which is coupled to the buckle so as to assemble the relay module to the casing.

7. A power supply of a computer having a power output device; the power output device comprising:
two power output ports;
at least one relay module; each relay module has a first module and a second module; one end of first and second module being installed with a respective power input port and another end thereof being installed with a plurality of slots; and
a plurality of first conductive wires; one end of each first conductive wire being connected to a connecting plug and another end of the first conductive wire being connected to an external plug; the connecting plug being connected to one of the slot and the external plug being connected to a computer peripheral device.

8. The power supply of a computer as claimed in claim 7, wherein a casing of the power supply is installed with a main cable and the power output ports.

9. The power supply of a computer as claimed in claim 7, wherein each power output port has a seat which is selected from one of a male seat and a female seat and each power input port has a seat which is selected from one of a male seat and a female seat; the seats of the power input ports are insertable into the seats of the power output ports.

10. The power supply of a computer as claimed in claim 7, wherein the power output ports are connected to the power input ports through at least one second conductive wires.

11. The power supply of a computer as claimed in claim 9, wherein the seats of the power output ports are connected to the seats of the power inputs port through at least one second conductive wire.

12. The power supply of a computer as claimed in claim 7, wherein a lateral side of each relay module is installed with a buckle and the casing is formed with embedding grooves which are coupled to the buckles so as to assemble the relay module to the casing.
